(19) United States
(12) Patent Application Publication
(10) Pub. No.: US 2017/0071328 A1
(43) Pub. Date: Mar. 16, 2017

(54) HOLD A DENTAL CLEANING DEVICE ON FOOD/DRINK RELATED ITEMS OR ACCESSORIES

(71) Applicant: NEVAAN KOTHARI, HENRICO, VA (US)

(72) Inventor: NEVAAN KOTHARI, HENRICO, VA (US)

(21) Appl. No.: 14/851,350

(22) Filed: Sep. 11, 2015

(51) Int. Cl. A46B 15/00; A61C 15/04; A45D 44/18; A61C 15/02

(52) U.S. Cl. CPC A46B 15/0055; A61C 15/02; A61C 15/046; A45D 44/18

(57) ABSTRACT

A holding mechanism for coupling a dental cleaning device to a dish, food container, or food implement. The holding mechanism includes a clip that grasps a rim of the dish, food container, or food implement, and includes a gripper for holding the dental cleaning device. The holding mechanism allows a user to attach a dental cleaning device such as a toothbrush to a dish such as a plate, so that the user is reminded to clean their teeth and has easy access to the dental cleaning device after eating.

### FIELD OF THE INVENTION

The present application relates to holding (for example: attaching, affixing, inserting, placing, embedding, etc.) a dental cleaning device on food accessories such as food utensils, food containers, bags used for carrying foods, etc.

### BACKGROUND

Dental cavities, gum problems and tooth decay problems have been increasing at an alarming rate. Whether its children or adults, one of the big problems is that the people keep on having foods during their entire day, but majority of the people only clean their teeth or gums either once or twice a day, and that too usually in the morning or right before going to bed at night. However, the plaque or the bacteria keeps on building up on the teeth and/or the gums the entire day, especially when the sugary or starchy foods are often stuck in the teeth or gums and the resulting bacteria is allowed to linger in the mouth for longer duration.

One of the problems is that the dental cleaning devices aren't often readily available everywhere and since a dental cleaning device isn't currently held (for example: attached, affixed, inserted, placed, embedded, etc.) on food accessories such as food utensils, food containers, and bags used for carrying foods, so there isn't any option or even a visual reminder for the users to frequently clean their teeth and/or gums. In fact, currently when the dental cleaning devices are referred, they are usually only found in the washrooms or bathrooms, and it's completely non-obvious to see those dental cleaning devices being held (for example: attached, affixed, inserted, placed, embedded, etc.) on the food accessories. In short, often due to the unavailability of the dental cleaning devices right next to or on the food accessories, teeth or gum cleaning isn't done by the users on a frequent basis, which not only leads to a lot of dental problems but also huge expenses are incurred to treat and resolve those dental problems.

### BRIEF SUMMARY

This solution demonstrates a mechanism and exemplary apparatus to hold (for example: attach, affix, insert, place, embed, etc.) a dental cleaning device on food accessories such as food utensils, food containers, and bags used for carrying food or drinks. With this solution, it will not only make the dental cleaning devices easily accessible to the users i.e. either right next to or on the food accessories, but also provide a visual reminder to those users so they can frequently clean their teeth or gums, and therefore, avoid a lot of dental problems and their associated expenses. In short, whether its children or adults, this non-obvious solution of making the dental cleaning devices available right next to or on the food accessories will promote and inculcate good habit of frequently cleaning the teeth or gums after having different foods, and therefore, help to maintain good oral hygiene in the long run.

This solution would mainly include a dental cleaning device and a food accessory. Additionally, in situations where a dental cleaning device is attached to the food accessory, this solution can also include a built-in or add-on attachment to attach the dental cleaning device to the food accessory. Additionally, in situations where a dental cleaning device is inserted or placed on the food accessory, this solution can also include a placeholder indicator on the food accessory to indicate that the specially designated section has been allocated for keeping the dental cleaning devices. Moreover, when a dental cleaning device is inserted within the food accessory, this solution can also include an inserting mechanism, which helps to hold the dental cleaning device within that food accessory. In addition, to protect the bristles or protect the entire dental cleaning device, this solution can also include a cover for either a part of or the entire dental cleaning device. A person of ordinary skill in the art would recognize that this solution can also include other components that might be necessary to hold (for example: affix, attach, insert, place, embed, mold, suspend, glue, fasten, secure, stick, fix, pin, include, put, add, position, root in, set in, implant, etc.) a dental cleaning device on food accessories without departing from the spirit and scope of the present invention.

According to an embodiment of the present invention, it illustrates a mechanism to hold the food accessory and the dental cleaning device together, comprising: a food accessory; a dental cleaning device; and a holding mechanism that holds the food accessory and the dental cleaning device together.

According to an embodiment of the present invention, the holding mechanism includes partially or completely attaching the dental cleaning device and the food accessory together using an attachment.

According to an embodiment of the present invention, an attachment can be attached either to the food accessory or to the dental cleaning device or on both of them.

According to an embodiment of the present invention, one of the examples of an attachment includes an attracting magnet attached to either the food accessory or to the dental cleaning device or on both of them.

According to an embodiment of the present invention, an attachment is capable of holding a dental cleaning device either directly on it or using further embedded or attached components on it.

According to an embodiment of the present invention, the holding mechanism includes inserting the dental cleaning device within the food accessory using an inserting mechanism.

According to an embodiment of the present invention, the holding mechanism includes placing the dental cleaning device on the food accessory at a specially designated location.

According to an embodiment of the present invention, the specially designated location on the food accessory includes a placeholder indicator indicating that the dental cleaning device can be placed in that location.

According to an embodiment of the present invention, the holding mechanism includes a special holding structure embedded on the food accessory that can hold the dental cleaning device.

According to an embodiment of the present invention, the holding mechanism includes embedding the dental cleaning device, either partially or completely, within the food accessory.

According to an embodiment of the present invention, the holding mechanism includes partially or completely affixing the dental cleaning device and the food accessory together.

According to an embodiment of the present invention, the holding mechanism includes any component or material, along with any shape or form, that can assist to hold the dental cleaning device and the food accessory together.

According to an embodiment of the present invention, the food accessory directly holds the dental cleaning device or the cover of the dental cleaning device using either temporary or permanent fastening or adhesive.

According to an embodiment of the present invention, the dental cleaning device has a clip mechanism on it such that the dental cleaning device can be attached to other objects.

According to an embodiment of the present invention, a food accessory that can hold a dental cleaning device comprising: a food accessory; and a holding apparatus on the food accessory that can hold a dental cleaning device.

According to an embodiment of the present invention, the holding apparatus includes an attachment affixed to the food accessory that is capable of holding a dental cleaning device either directly on it or using further embedded or attached components on it.

According to an embodiment of the present invention, the holding apparatus includes a special holding structure embedded on the food accessory to hold a dental cleaning device.

According to an embodiment of the present invention, the holding apparatus includes a specially designated location on the food accessory that can hold the dental cleaning device.

According to an embodiment of the present invention, the specially designated location on the food accessory includes a placeholder indicator indicating that the dental cleaning device can be placed in that location.

According to an embodiment of the present invention, the holding apparatus on the food accessory includes any component or material, along with any shape or form, that can assist to hold the dental cleaning device.

According to an embodiment of the present invention, the food accessory directly holds the dental cleaning device or the cover of the dental cleaning device using either temporary or permanent fastening or adhesive.

According to an embodiment of the present invention, one of the examples of the food accessory that directly holds the dental cleaning device includes a piece of cutlery with the dental cleaning bristles permanently attached to its handle.

According to an embodiment of the present invention, the food accessory is molded around the dental cleaning device such that the dental cleaning device is partially or completely embedded within the food accessory.

According to an embodiment of the present invention, a dental cleaning device that can be held on a food accessory comprising: a dental cleaning device; and a holding apparatus on the dental cleaning device that enables the dental cleaning device to be held on the food accessory.

According to an embodiment of the present invention, the holding apparatus includes an attachment affixed to the dental cleaning device that enables the dental cleaning device to be held on to the food accessory.

According to an embodiment of the present invention, the dental cleaning device or the cover of the dental cleaning device directly attaches to the food accessory using either temporary or permanent fastening or adhesive.

According to an embodiment of the present invention, the holding apparatus includes any component or material, along with any shape or form, that enables the dental cleaning device to be held on to the food accessory.

According to an embodiment of the present invention, the dental cleaning device includes multiple layers of its handle such that any of those handle layers can be removed or added back to the dental cleaning device.

According to an embodiment of the present invention, the dental cleaning device is partially or completely covered with mouth freshener.

### DEFINITION/EXPLANATION OF KEY TERMS

Dental cleaning device can be any other form of device that can be used to clean the teeth and/or gums, regardless of its size, material or shape. Here are some examples of the dental cleaning devices—conventional toothbrush, automated toothbrush, finger toothbrush, foldable toothbrush, one-time use toothbrush, dental floss, mouthwash, cleaning bristles, dental cleaning twig, chewing stick, dental probiotic capsules, etc. A person of ordinary skill in the art would recognize that instead of the above examples any device that can clean the teeth and/or gums can also be used without departing from the spirit and scope of the present invention.

Food utensils can be any type of vessel or utensil where food is usually placed for consumption, regardless of their size, material or shape. For example: a food utensil material can include either ceramic, plastic, paper, foam, metal, glass, or in fact, any other type of material. Here are some examples of the food utensils—crockery, plates, cups, bowls, mugs, glasses, pans, earthenware, etc. A person of ordinary skill in the art would recognize that instead of the above examples any vessel or utensil that can hold food for consumption can also be used without departing from the spirit and scope of the present invention.

Food containers can be any type of containers that can store food products regardless of their size, material or shape. For example: a food container material can include either plastic, paper, foam, metal, glass, or in fact, any other type of material. Here are some examples of the food containers—boxes, wraps, packets, pouches, cans, bottles, etc. A person of ordinary skill in the art would recognize that instead of the above examples any food container that can store food can also be used without departing from the spirit and scope of the present invention.

Food accessories can be a variety of products where food may or may not be placed in those accessories, but those accessories are usually directly or indirectly involved with the foods and drinks and can sometimes even be decorative in nature. (Note: Such food accessories can be of any size, material or shape.) For example: serving utensils, cutlery/silverware such as knife, fork, spoon, etc., food utensil holders, cutlery holders, dining table mats, dining table linen, dining table centerpiece, dining table decorative items, paper napkins, table napkins, table cover, etc. A person of ordinary skill in the art would recognize that instead of the above examples any food accessories that are directly or indirectly involved with foods can also be used without departing from the spirit and scope of the present invention.

Bags used for carrying foods, food containers or food accessories can be any type of bags regardless of their size, material or shape. Here are some examples of such bags—plastic or paper bag, handbag, purse, luggage bag, laptop bag, etc. A person of ordinary skill in the art would recognize that instead of the above examples any bag that can carry foods, food containers or food accessories can also be used without departing from the spirit and scope of the present invention.

Food products can be either solid, semi-solid, liquid or any other type of foods or beverages that are edible. This would also include any foods/drinks that need to be prepared (for example: boiled, baked, fried, cooked, etc.) before consumption. Here are some examples of the food products—an ice cream, an ice popsicle, kabab on sticks, a lollipop chocolate, or any breakfast, lunch, or dinner foods, etc. A person of ordinary skill in the art would recognize that instead of the above examples any other food can also be used without departing from the spirit and scope of the present invention.

A person of ordinary skill in the art would recognize that anywhere in this document when it's referred that the dental cleaning device is held on the food accessory, meaning of ‘held’ can include either being attached, affixed, inserted, placed, embedded, molded, suspended, glued, fastened, secured, stuck, fixed, pinned, included, put, added, positioned, rooted in, set in, implanted, etc., and all of these can be used interchangeably within the entire document without limiting their usage for a specific embodiment. (For example: if an embodiment of the present invention refers to a dental cleaning device being attached to a food accessory, then instead of being attached, the dental cleaning device can also be inserted, placed, embedded, molded, suspended, glued, fastened, secured, stuck, fixed, pinned, included, put, added, positioned, rooted in, set in, implanted, etc. on the food accessory, and that would be within the spirit and scope of the present invention.) Also, A person of ordinary skill in the art would also recognize that in addition to the above examples of ‘held’, any other meanings of ‘held’ would also be considered within the spirit and scope of the present invention.

### BRIEF DESCRIPTION OF THE DRAWINGS

FIG. 1 illustrates an exemplary dental cleaning device, a conventional toothbrush, attached to an exemplary food utensil, a plate, using an attachment.

FIG. 2 illustrates an exemplary dental cleaning device, a conventional toothbrush with a cover for keeping bristles clean, attached to an exemplary food utensil, a plate, using an attachment.

FIG. 3 illustrates an exemplary food utensil, a plate with a built-in extension to hold an exemplary dental cleaning device, a conventional toothbrush, and an exemplary dental cleaning accessory, a toothpaste.

FIG. 4 illustrates an exemplary food utensil, a plate, with a built-in compartment and an exemplary placeholder indicator to hold an exemplary dental cleaning device, a dental floss within its protective cover.

FIG. 5 illustrates an exemplary food utensil, a plate with a built-in compartment and an exemplary placeholder indicator to hold an exemplary dental cleaning device, a conventional toothbrush.

FIG. 6 illustrates an exemplary food utensil, a plate with a built-in compartment, an exemplary placeholder indicator and an exemplary holding unit to hold an exemplary dental cleaning device, a foldable toothbrush.

FIG. 7 illustrates an exemplary food utensil, a plate with a built-in extension to hold an exemplary dental cleaning device, a toothbrush with replaceable front bristles.

FIG. 8 illustrates an exemplary food utensil, a plate with an attached wire that connects the plate and an exemplary dental cleaning device, a conventional toothbrush with a cover for keeping bristles clean.

FIG. 9 illustrates an exemplary food utensil, a disposable plate, with an attached exemplary dental cleaning device, a conventional toothbrush that can be snapped out of the utensil.

FIG. 10 illustrates an exemplary food utensil, a bowl with a built-in extension to hold an exemplary dental cleaning device, a finger toothbrush.

FIG. 11 illustrates an exemplary food utensil, a mug with a built-in holding unit to hold an exemplary dental cleaning device, a teeth cleaning chewing stick.

FIG. 12 illustrates an exemplary dental cleaning device, a conventional toothbrush, attached to an exemplary food container, a carry out box, using an attachment.

FIG. 13 illustrates an exemplary dental cleaning device, a conventional toothbrush with a cover for keeping bristles clean, attached to an exemplary food container, a carry out rectangular box, using a tape.

FIG. 14 illustrates an exemplary food container, a lunch box with a special compartment to hold an exemplary dental cleaning device, a conventional toothbrush with a cover for keeping bristles clean, and an exemplary dental cleaning accessory, a toothpaste.

FIG. 15 illustrates an exemplary food container, a box, with a built-in compartment to hold an exemplary dental cleaning device, a conventional toothbrush, using magnet that's affixed to both the exemplary food container and the exemplary dental cleaning device. (Note: when one of the exemplary food container or the exemplary dental cleaning device is completely or partially made of ferrous components like iron, cobalt, nickel, etc, then the magnet would just need to be affixed to the remaining food container or the dental cleaning device since the magnet would attract to the ferrous objects.) Additionally, as shown in the figure, there can also an exemplary placeholder indicator on the box, indicating the specially allocated dental cleaning device section.

FIG. 16 illustrates an exemplary dental cleaning device, a dental floss within its protective case and covered in a plastic wrap, that's inserted in a pouch attached to an exemplary food container, a box of cookies. In addition, the figure also illustrates an exemplary dental cleaning device, a conventional toothbrush, attached to the flap/cover/lid of the food container using an attachment (for example: a tape). This figure demonstrates how the dental cleaning devices can be attached or inserted at prominent locations of the food container.

FIG. 17 illustrates an exemplary dental cleaning device, a conventional toothbrush covered in a plastic wrap, and suspended/inserted in an exemplary food container, i.e. a big packet of chocolates using a suspender that's attached (for example: glued) to the food container on one of its sides and attached (for example: glued) to the dental cleaning device (or its cover) on the other side.

FIG. 18 illustrates an exemplary dental cleaning device, a foldable toothbrush with a magnet on its handle, which allows it to be attached to an exemplary metal food container, an iron box.

FIG. 19 illustrates an exemplary food container, a bottle with an attachment, which can hold an exemplary dental cleaning device, a conventional toothbrush.

FIG. 20 illustrates an exemplary food container, a box of chocolates, with a special compartment to hold exemplary dental cleaning device, i.e. a dental floss, wherein the dental floss case is affixed to the said special compartment of the box using an adhesive.

FIG. 21 illustrates an exemplary food container, a big plastic packet of chocolates, which has a separate section to hold exemplary dental cleaning devices, i.e. multiple Y shaped dental flosses. In addition, there is also a separate cover for opening the dental cleaning devices' section.

FIG. 22 illustrates an exemplary food container, a chocolate wrapper, with an attached exemplary dental cleaning device, a dental floss within a cover, surrounding the outer wall of the wrapper.

FIG. 23 illustrates an exemplary food container, an open chocolate wrapper, with an attached exemplary dental cleaning device, a dental floss within a cover, located within multiple folds of the inner wall of the wrapper.

FIG. 24 illustrates an exemplary food container, a packet of chocolate bar, with an attached exemplary dental cleaning device, a conventional toothbrush with a cover for keeping bristles clean. The attachment illustrated in the figure is that of a booger glue or E-Z-Release glue, which provides temporary adhesiveness and helps to attach the dental cleaning device to the food container i.e. a packet of chocolate bar.

FIG. 25 illustrates an exemplary food container, a cylindrical metal can with an attachment to hold an exemplary dental cleaning device, a conventional toothbrush along with a cover to keep bristles clean.

FIG. 26 illustrates exemplary food related accessory, a spoon and a fork, which have an exemplary dental cleaning device, i.e. bristles, embedded or attached at the back of the utensil handle, and the bristles have a cover in order to keep them clean.

FIG. 27 illustrates exemplary dental cleaning devices, a conventional toothbrush and a dental floss within their respective covers, inserted within a separate section of an exemplary food related accessory, a folded table napkin, which also holds the conventional fork, knife, spoon, etc. within that same table napkin.

FIG. 28 illustrates an exemplary bag, i.e. a purse carrying either food, food container or food accessories, and includes a separate section that can hold the dental cleaning devices such as an antiseptic mouthwash, etc. Additionally, there is also an exemplary placeholder indicator on the purse i.e. text referring to the dental cleaning device section on the purse.

FIG. 29 illustrates an exemplary bag, i.e. a purse carrying either food, food container or food accessories, and also has a built-in wire connecting the bag and the exemplary dental cleaning device, a conventional toothbrush along with a cover to keep bristles clean.

FIG. 30 illustrates an exemplary dental cleaning device, a conventional toothbrush, attached to an exemplary food related accessory, a dining table mat using an attachment. In addition, there is also an exemplary placeholder indicator on the dining table mat, indicating that the dental cleaning device can be kept on that special section of the dining table mat. Additionally, as illustrated in the figure, conventional toothbrush can also have a cover for keeping bristles clean.

FIG. 31 illustrates an exemplary food related accessory, a cutlery holder, with a built-in compartment to also hold an exemplary dental cleaning device, a regular toothbrush, along with the conventional fork, knife, spoon, etc. Additionally, as illustrated in the figure, the dental cleaning device section of the cutlery holder can also include partition holes at the top, which would allow to keep the dental cleaning devices separate from each other and protect their bristles. In addition, the figure also illustrates an exemplary placeholder indicator on the cutlery holder, referring to the dental cleaning device section of the food related accessory.

FIG. 32 illustrates exemplary multiple dental cleaning devices, a conventional toothbrush and a foldable toothbrush, hanging on an exemplary food related accessory, a dining table centerpiece, using the attachments. Note: Conventional toothbrush also has a cover for keeping bristles clean.

FIG. 33 illustrates an exemplary dental cleaning device, a conventional toothbrush with a cover for keeping bristles clean and a clip mechanism embedded at the bottom of the toothbrush handle that allows the toothbrush to be clipped to an exemplary bag (for example: a plastic bag) carrying either food, food container or food accessories.

FIG. 34 illustrates exemplary dental cleaning devices, a conventional toothbrush with a cover for keeping bristles clean, a dental floss with a cover for keeping it clean, an antiseptic mouthwash and a Y shaped dental floss covered in plastic, inserted in the specially allocated dental cleaning device section in the front pouch of an exemplary bag carrying either food, food container or food accessories i.e. a laptop bag with food in its front pouch. In addition, the figure also illustrates an exemplary placeholder indicator on the laptop bag, indicating the dental cleaning device section where the dental cleaning devices can be kept.

FIG. 35 illustrates an exemplary dental cleaning device, a conventional toothbrush with a cover for keeping bristles clean, inserted in a specially allocated dental cleaning device section of an exemplary bag carrying either food, food container or food accessories i.e. a hand luggage bag.

FIG. 36 illustrates an exemplary dental cleaning device, a cleaning stick, which is embedded in the center of an exemplary food product, an ice cream, instead of a regular wooden stick in the center.

FIG. 37 illustrates an exemplary dental cleaning device, a cleaning stick, that's affixed (for example: glued) to the back of a kabab stick (skewers), which is further inserted in an exemplary food product, a kabab.

FIG. 38 illustrates an exemplary dental cleaning device, a cleaning twig, where a part of the cleaning stick is embedded on an exemplary food product, a lollipop chocolate, and the remaining part of the cleaning stick acts as an handle to hold the food product.

FIG. 39 illustrates an exemplary dental cleaning device, an upside down conventional toothbrush with a bristle cover, where the handle of that toothbrush is embedded in the center of an exemplary food product, a lollipop chocolate, rather than a traditionally used plastic stick in the center. In addition, the figure also illustrates that a toothbrush can also have multiple layers of its handle, such that the sticky top layer can be removed from the toothbrush by twisting that layer counter-clockwise and unscrewing the layer from the swirly threads of the handle, leaving the internal layer of the toothbrush handle still intact.

FIG. 40 illustrates exemplary dental cleaning devices, i.e. multiple toothbrushes along with bristle covers, where each toothbrush is inserted using individual attachments on an exemplary food related accessory, a restaurant bill/check holder. In addition, the figure also illustrates that an exemplary dental cleaning device, i.e. a toothbrush, can also include mouth freshener covered bristles.

### DETAILED DESCRIPTION

This solution demonstrates a mechanism and exemplary apparatus to hold (for example: attach, affix, insert, place, embed, etc.) a dental cleaning device on food accessories such as food utensils, food containers, food accessories, bags used for carrying foods, food containers or food accessories, food products themselves, etc. With this solution, it will not only make the dental cleaning devices easily accessible to users i.e. either right next to or on the food accessories itself, but also provide a visual reminder to those users so they can frequently clean their teeth or gums, and therefore, avoid a lot of dental problems and their associated expenses. In short, whether its children or adults, this non-obvious solution of making the dental cleaning devices available right next to or on the food accessories itself will promote and inculcate good habit of frequently cleaning the teeth or gums after having different foods, and therefore, help to maintain good oral hygiene in the long run. The term “food” used throughout this application shall include both food and drink or beverage, consistent with the commonly understood, expansive meaning of food.

This solution would mainly include a dental cleaning device and a food accessory. Additionally, in situations where a dental cleaning device is attached to the food accessory, this solution can also include a built-in or add-on attachment to attach the dental cleaning device to the food accessory. Additionally, in situations where a dental cleaning device is inserted or placed on the food accessory, this solution can also include a placeholder indicator on the food accessory to indicate that the specially designated section has been allocated for keeping the dental cleaning devices. Moreover, when a dental cleaning device is inserted within a food accessory, this solution can also include an inserting mechanism, which would help to hold the dental cleaning device within that food accessory. Note: Such inserting mechanism can include any material, shape or method as long as it can help to hold the dental cleaning device within the food accessory. Additionally, to protect the bristles and/or protect the entire dental cleaning device, this solution can also include a cover for either a part of or the entire dental cleaning device. A person of ordinary skill in the art would recognize that this solution can also include other components that might be necessary to hold (for example: affix, attach, insert, place, embed, mold, suspend, glue, fasten, secure, stick, fix, pin, include, put, add, position, root in, set in, implant, etc.) a dental cleaning device on food accessories without departing from the spirit and scope of the present invention.

### Here are Some of the Common Features that would be Applicable to the Various Types of Exemplary Embodiments of the Present Invention

For those embodiments of the present invention where a dental cleaning device is attached to a food accessory, A person of ordinary skill in the art would recognize that the attachment used can be any form of apparatus that has one of its sides attachable or fixed to the food accessory and the other end attaches to or holds the dental cleaning device. Such an attachment can be made of any material and include any shape as long as it can attach to or hold the dental cleaning device.

For example, there can be attachment that's attached to a food accessory on one side and the other end of the attachment has a flexible rubber claw, such that the dental cleaning device can be pressed inside the rubber claw. Another example of an attachment can be an independent clip that is affixed (for example: attached, glued, embedded, etc.) to a dental cleaning device on one side, and using that clip the dental cleaning device can be attached to a food accessory. Another example of an attachment can be a partial clip comprising of one arm and spring mechanism attached to the dental cleaning device such that the base of the dental cleaning device acts as the other arm of the clip, allowing the dental cleaning device to be attached to a food accessory. Another example of an attachment can be a solid material with hole in the center that can hold a dental cleaning device, and that solid material is affixed (for example: attached, glued, etc.) to the food accessory on one side. Another example of an attachment can be a wire that is attached to a dental cleaning device on one side, and a food accessory on the other side. Another example of an attachment can be a plastic cover that can hold the dental cleaning device within it and is attached (for example: temporary adhesive that produces a non-permanent joint) to the food accessory. Another example of an attachment can be a magnet that is either attached or embedded on a dental cleaning device, allowing the cleaning device to stick to food accessories that can attract magnets. Such attachment in the form of magnet on a dental cleaning device can also be attached to other magnets that are affixed on the food accessories itself. Overall, A person of ordinary skill in the art would recognize that an attachment isn't just limited to any of the exemplary details mentioned above and can be any other type of attachment.

Note: The attachment mentioned above can also have self-contained means so it can be readily secured to the food accessories, or the dental cleaning device itself without any external support. For example, the connecting end of the attachment can be like a clip shaped structure along with a groove in it, which allows it to maintain a strong grip and can be attached to various food accessories, or the dental cleaning device itself. In another instance, an attachment can also be directly affixed (for example: glued, attached, etc.) to the food accessories, or the dental cleaning device itself, so the attachment doesn't need to be secured each time. A person of ordinary skill in the art would recognize that an attachment isn't just limited to any of the exemplary details mentioned above and can be any other type of attachment.

Additionally, the attachment mentioned above can also be dishwasher safe. A person of ordinary skill in the art would recognize that an attachment isn't limited to any of the exemplary details mentioned above and can also include other components, combinations and features that might be necessary to be able to attach a dental cleaning device to food accessories without departing from the spirit and scope of the present invention.

For those embodiments of the present invention where a dental cleaning device is attached to a food accessory using an attachment, those dental cleaning devices would be allowed to be detachable for use and then can also be re-attached later.

For those embodiments of the present invention where a dental cleaning device is inserted within a food accessory, A person of ordinary skill in the art would recognize that the inserting mechanism used can be any form or method as well as any shape or material as long as it can hold the dental cleaning device within the food accessory. For example, there can be a pouch affixed inside the food accessory where a dental cleaning device can be inserted. Another example of an inserting mechanism can be a suspended material, for example: a hanging thread, etc., that's affixed to the food accessory on one end and holds the dental cleaning device on the other end, etc. Note: The above mentioned examples are just exemplary and there can also be other instances of inserting mechanisms that can hold the dental cleaning device within the food accessory, and that would also be within the spirit and scope of the present invention.)

For those embodiments of the present invention where a dental cleaning device is held (for example: attached, affixed, inserted, placed, embedded, etc.) on a food accessory, A person of ordinary skill in the art would recognize that the front view of the dental cleaning device can be facing any direction i.e. on the sides, top, bottom, etc. and that would be within the spirit and scope of the present invention.

For those embodiments of the present invention where a dental cleaning device is held (for example: attached, affixed, inserted, placed, embedded, etc.) on a food accessory, A person of ordinary skill in the art would recognize that the dental cleaning device can also be covered in either full or partial cover before it's held (for example: attached, affixed, inserted, placed, embedded, etc.) on the food accessory, and that would be within the spirit and scope of the present invention.

For those embodiments of the present invention where a dental cleaning device is just a plain toothbrush, A person of ordinary skill in the art would recognize that although use of toothpastes along with a toothbrush can help to further reduce plaque and gum bleeding, however, even brushing the teeth with a plain toothbrush can also help to reduce plaque build-up and gum bleeding to a good extent. Therefore, not cleaning the teeth or gums can be much more harmful as compared to cleaning the teeth or gums with at least a plain toothbrush. On the other hand, A person of ordinary skill in the art would also recognize that although a user can just use a plain toothbrush for cleaning teeth or gums, however, if the user does have access to a toothpaste or similar products, then they can certainly use those additional products in addition to their plain toothbrush, and that would be within the spirit and scope of the present invention.

For those embodiments of the present invention where a dental cleaning device is any type of toothbrush with bristles, the material used for the handle of the toothbrush, the bristles or any other part of the toothbrush along with its cover would all be dishwasher safe, so a toothbrush can be simply placed in dishwasher after usage for thorough cleaning and removal of germs, allowing it to be reusable later. Similar to how a silverware isn't usually assigned to an individual but rather shared among users after each usage, this dishwasher safe capability of the toothbrush would also allow the users to be able to share the toothbrush after each usage rather than worrying about the traditional concept of unique toothbrush assigned to each individual.

For those embodiments of the present invention where a dental cleaning device is placed on a food accessory, there can be either an embossed or debossed placeholder image of dental cleaning device or placeholder text referring to dental cleaning device on the food accessory, showing that a dental cleaning device can be placed in that specially designated section of the food accessory. Note: such placeholders can also be regular image or text (which aren't embossed or debossed) or another feature as long as they can convey the intent of placing a dental cleaning device on the particular section of food accessory. Such placeholders would also provide a visual reminder to the users that a dental cleaning device can be placed in those assigned sections. A person of ordinary skill in the art would recognize that such placement of dental cleaning device isn't limited to any of the exemplary details mentioned above and can also include other components, combinations and features that can convey the intent of placing a dental cleaning device in a particular section of the food accessory without departing from the spirit and scope of the present invention.

For those embodiments of the present invention where a dental cleaning device is held (for example: attached, affixed, inserted, placed, embedded, etc.) on a food accessory, A person of ordinary skill in the art would recognize that multiple dental cleaning devices can also be held (for example: attached, affixed, inserted, placed, embedded, etc.) on a food accessory without departing from the spirit and scope of the present invention.

For those embodiments of the present invention where multiple dental cleaning devices are held (for example: attached, affixed, inserted, placed, embedded, etc.) on a food accessory, A person of ordinary skill in the art would recognize that each dental cleaning device can have a different color such that those users who might not be willing to share their dental cleaning devices with others can have a specific colored dental cleaning device assigned to them, and that would be within the spirit and scope of the present invention.

### Several Exemplary Embodiments of the Present Disclosure are Described Herein Below with Reference to the Accompanying Drawings

These exemplary embodiments demonstrate how a dental cleaning device can be held (for example: attached, affixed, inserted, placed, embedded, etc.) on a food accessory. However, it is to be clearly understood that the disclosed embodiments are merely exemplary of the disclosure and may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

Note: A person of ordinary skill in the art would recognize that there are many different types of dental cleaning devices, food utensils, food containers, food accessories, bags used for carrying foods or food containers or food accessories, and the food products themselves, etc. Therefore, rather than limiting the invention to just the embodiments shown in this document, it is to be clearly understood that all other dental cleaning devices, food utensils, food containers, food accessories, bags used for carrying foods or food containers or food accessories, food products themselves, etc. would also be within the spirit and scope of the present invention.

Additionally, A person of ordinary skill in the art would recognize that any of the illustrated figures of this invention can also have substitute components, combinations and features as long as the intent of holding (for example: attaching, affixing, inserting, placing, embedding, etc.) a dental cleaning device on the food accessory is maintained.

Additionally, A person of ordinary skill in the art would recognize that anywhere in this document when it's referred that the dental cleaning device is held on the food accessory, meaning of ‘held’ can include either being attached, affixed, inserted, placed, embedded, molded, suspended, glued, fastened, secured, stuck, fixed, pinned, included, put, added, positioned, rooted in, set in, implanted, etc., and all of these can be used interchangeably within the entire document without limiting their usage for a specific embodiment. (For example: if an embodiment of the present invention refers to a dental cleaning device being attached to a food accessory, then instead of being attached, the dental cleaning device can also be inserted, placed, embedded, molded, suspended, glued, fastened, secured, stuck, fixed, pinned, included, put, added, positioned, rooted in, set in, implanted, etc. on the food accessory, and that would be within the spirit and scope of the present invention.) Also, A person of ordinary skill in the art would also recognize that in addition to the above examples of ‘held’, any other meanings of ‘held’ would also be considered within the spirit and scope of the present invention.

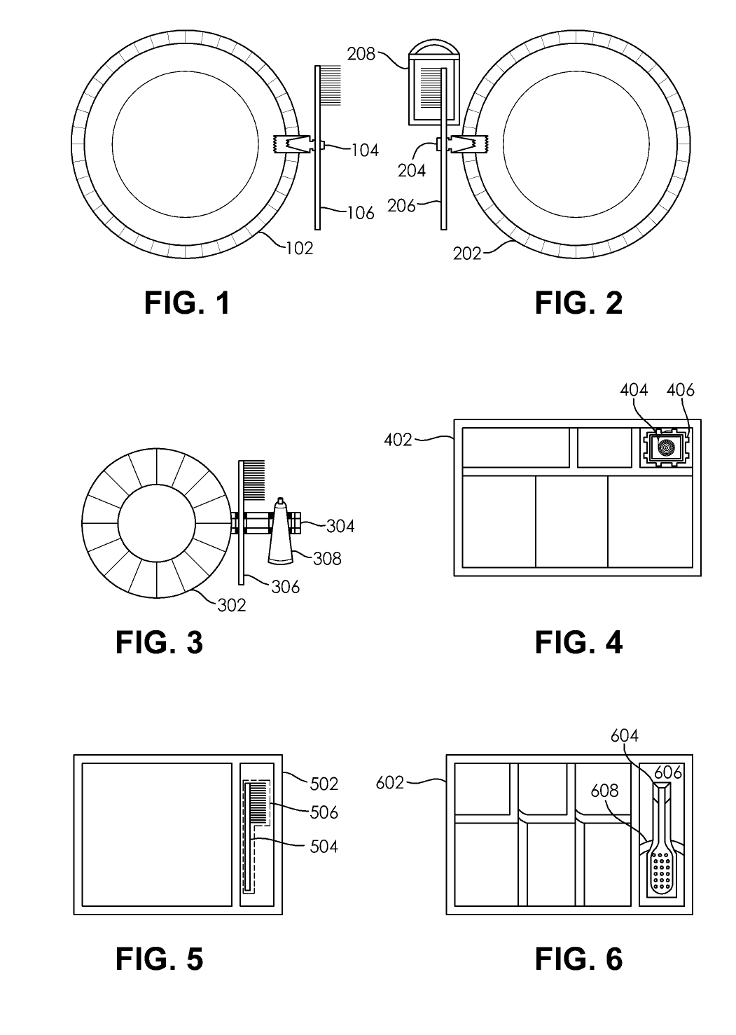

According to an embodiment of the present invention, as shown in FIG. 1, it illustrates an exemplary dental cleaning device, a conventional toothbrush 106, attached to an exemplary food utensil, a plate 102, using an attachment 104. The exemplary attachment 104 includes a clip like structure with grooves on the attaching end, which helps to secure it to the rim of the plate, and the other end of the clip includes a claw shaped rubber structure where a dental cleaning device can be pressed to fit in it.

This embodiment shown in FIG. 1 is just exemplary, however, it shows how a dental cleaning device can be easily attached to the food accessories, providing a visual reminder to the users to frequently clean their teeth or gums and also making the dental cleaning devices within easy access of the users. This easy access of dental cleaning devices can indirectly enable the users to frequently clean their teeth or gums, and therefore, avoid a lot of dental problems and their associated expenses. Please note that the dental cleaning device shown in the exemplary embodiment would be allowed to be detachable for use and then would also be allowed to be re-attachable later for future usage.

According to an embodiment of the present invention, as shown in FIG. 2, it illustrates an exemplary dental cleaning device, a conventional toothbrush 206 with a cover 208 for keeping bristles clean, attached to an exemplary food utensil, a plate 202, using an attachment 204. Similar to the attachment 104 shown in FIG. 1, the exemplary attachment 204 includes a clip like structure with grooves on the attaching end, which helps to secure it to the rim of the plate, and the other end of the clip includes a claw shaped rubber structure where a dental cleaning device can be pressed to fit in it. In short, the primary intent of this FIG. 2 is to demonstrate that a cover 208 can also be used along with the dental cleaning device in order to keep it clean while the dental cleaning device is attached to a food accessory.

According to an embodiment of the present invention, as shown in FIG. 3, it illustrates an exemplary food utensil, a plate 302 with a built-in extension i.e. a special holding structure 304 to hold an exemplary dental cleaning device, a conventional toothbrush 306, and an exemplary dental cleaning accessory, a toothpaste 308. Such extension 304 can be made of either the same material as the food utensil itself, or it can also be made of any other material as long as the material can be affixed to the food utensil and can hold the dental cleaning devices on it. Note: other components can also be attached or embedded on the built-in extension 304 to be able to hold the dental cleaning devices. For example, there can be a claw shaped rubber structure that's embedded on the built-in extension 304, which would allow to hold the dental cleaning devices along with the dental cleaning accessories. Note: the built-in extension would be affixed or fastened to the food utensil such that the extension can be folded beneath, above or within the product itself after usage, and therefore, not take up additional space during storage.

According to an embodiment of the present invention, as shown in FIG. 4, it illustrates an exemplary food utensil, a plate 402, with a built-in compartment and an exemplary placeholder indicator 406 to hold an exemplary dental cleaning device, a dental floss 404 within its protective cover. Note: the exemplary placeholder indicator 406 used here includes a debossed image of floss which indicates that the dental cleaning device can be placed in that specially allocated section of the food accessory. Note: Such exemplary placeholder indicators can either be an embossed, debossed or even regular placeholder image or text referring to a dental cleaning device, or it can also be another form of representation as long as they can convey the intent of placing a dental cleaning device on the particular section of food accessory. Such placeholders also serve as a visual reminder to the users that a dental cleaning device can be placed in the assigned sections of the food accessory. However, note that this invention would also include where users directly insert the dental cleaning device anywhere on or right next to the food accessories, without even the placeholder indicators being present.

According to an embodiment of the present invention, as shown in FIG. 5, it illustrates an exemplary food utensil, a plate 502 with a built-in compartment and an exemplary placeholder indicator 506 to hold an exemplary dental cleaning device, a conventional toothbrush 504. Note: the exemplary placeholder indicator 506 used here includes an embossed outline of toothbrush. Similar to FIG. 4, the main intent of such placeholder indicators is to remind users that dental cleaning devices are important to maintain good oral health, and therefore, deserve a spot either within or right next to the food accessories. However, note that this invention would also include where users directly insert the dental cleaning device anywhere on or right next to the food accessories, without even the placeholder indicators being present.

According to an embodiment of the present invention, as shown in FIG. 6, it illustrates an exemplary food utensil, a plate 602 with a built-in compartment, an exemplary placeholder indicator 606, and a holding unit 608 to hold an exemplary dental cleaning device, a foldable toothbrush 604. Note: the exemplary placeholder indicator 606 used here includes an embossed text referring to a dental cleaning device, which indicates that the cleaning device can be placed in that specially designated section of the food accessory. However, please note that this invention would also include where users directly insert the dental cleaning device anywhere on or right next to the food accessories, without even the placeholder indicators being present. In addition, the holding unit 608 shown in this embodiment can be made of either the same material as the food utensil itself, or it can also be made of any other material as long as the material can be affixed to the food utensil and can hold the dental cleaning device.

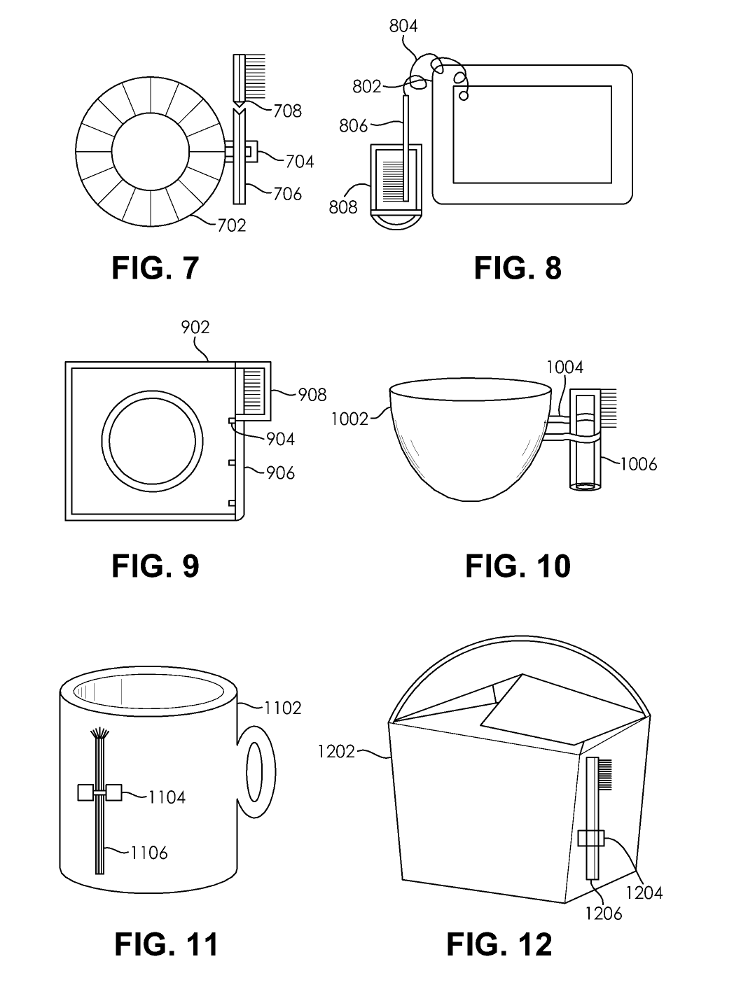

According to an embodiment of the present invention, as shown in FIG. 7, it illustrates an exemplary food utensil, a plate 702 with a built-in extension i.e. a special holding structure 704 to hold an exemplary dental cleaning device, a toothbrush 706 with replaceable front bristles 708. This toothbrush is similar to the use-and-throw concept, where once a user has used the toothbrush, they can take out the front bristles section and replace it with another one. Please note that the built-in extension 704 illustrated in FIG. 7 can be made of either the same material as the food utensil itself, or it can also be made of any other material as long as the material can be affixed to the food utensil and can hold the dental cleaning devices on it. Note: other components can also be attached or embedded on the built-in extension 704 to be able to hold the dental cleaning devices. For example, there can be a claw shaped rubber structure that's embedded on the built-in extension 704, which would allow to hold the dental cleaning devices. Note: the built-in extension would be affixed or fastened to the food utensil such that the extension can be folded beneath, above or within the product itself after usage, and therefore, not take up additional space during storage. Additionally, A person of ordinary skill in the art would recognize that such toothbrush with replaceable front bristles, as illustrated in the figure, can also exist separately on its own such it can also be inserted, embedded or placed on a food accessory without departing from the spirit and scope of the present invention.

According to an embodiment of the present invention, as shown in FIG. 8, it illustrates an exemplary food utensil, a plate 802 with an attached wire 804 that connects the plate and an exemplary dental cleaning device, a conventional toothbrush 806 with a cover 808 for keeping bristles clean. Such exemplary wire 804 can be either affixed (for example: glued) to the food related accessory as well as the dental cleaning device, or there can be a hole on the food related accessory as well as the dental cleaning device where the wire can be fastened on both sides. In addition, there can be also be a combination of wire being affixed, fastened to holes or other potential means can also be used to attach the wire to the food accessory as well as the dental cleaning device without restricting it to the examples mentioned above.

According to an embodiment of the present invention, as shown in FIG. 9, it illustrates an exemplary food utensil, a disposable plate 902, with an attached exemplary dental cleaning device, a conventional toothbrush 906, that can be snapped out of the utensil when the user wishes to clean their teeth or gums. As shown in the figure, the toothbrush is attached to the disposable plate at certain key points 904, so the toothbrush can be easily snapped out of the utensil. However, please note that the toothbrush can be attached in a number of other ways without restricting it to the example mentioned above. Additionally, the conventional toothbrush in the figure also has a cover 908 for keeping bristles clean, however, the cover is just for good hygiene purposes and isn't necessary.

According to an embodiment of the present invention, as shown in FIG. 10, it illustrates an exemplary food utensil, a bowl 1002 with a built-in extension 1004 to hold an exemplary dental cleaning device, a finger toothbrush 1006. As illustrated in the figure, the built-in extension 1004 includes a hole on one of its end, which can hold a dental cleaning device in it, and the other end is affixed to the food accessory. Please note that the built-in extension 1004 can be made of either the same material as the food utensil itself, or it can also be made of any other material as long as the material can be affixed to the food utensil and can hold the dental cleaning devices on it. If needed, other components can also be attached or embedded on the built-in extension 1004 to be able to hold the dental cleaning devices. Note: the built-in extension would be affixed or fastened to the food utensil such that the extension can be folded beneath, above or within the product itself after usage, and therefore, not take up additional space during storage.

According to an embodiment of the present invention, as shown in FIG. 11, it illustrates an exemplary food utensil, a mug 1102 with a built-in holding unit 1104 to hold an exemplary dental cleaning device, a teeth or gum cleaning chewing stick 1106. The built-in holding unit 1104 (i.e. a special holding structure) illustrated in the figure can be made of either the same material as the food utensil itself, or it can also be made of any other material as long as the material can be affixed to the food utensil and can hold the dental cleaning devices on it. For example, there can be a claw shaped rubber structure as the holding unit 1104, which would be affixed to the food utensil and would hold the dental cleaning device. Note: other components can also be attached/embedded on the built-in holding unit 1104 to be able to hold the dental cleaning devices. A person of ordinary skill in the art would recognize that such holding unit 1104 isn't limited to any of the exemplary details mentioned above and can also include other components, combinations and features that can hold the dental cleaning device on the food accessory without departing from the spirit and scope of the present invention. Additionally, the teeth or gum chewing stick shown in this FIG. 11 can also be replaced with a toothbrush or another type of dental cleaning device without departing from the spirit and scope of the present invention. In short, any of the illustrated figures of this invention can have substitute components, combinations and features as long as the intent of holding (for example: attaching, affixing, inserting, placing, embedding, etc.) a dental cleaning device on the food accessory is maintained.

According to an embodiment of the present invention, as shown in FIG. 12, it illustrates an exemplary dental cleaning device, a conventional toothbrush 1206, attached to an exemplary food container, a carry out box 1202, using a sticky back strip or hold down strip (For example: Velcro products) 1204. The sticky back strip 1204 would be fastened to both the food container as well as the dental cleaning device, which would allow those two products to attach together using the Velcro strip component. Note: even a simple tape or another sticking or attaching component can be used instead of a Velcro sticky back strip to attach the dental cleaning device to the food container without departing from the spirit and scope of the present invention. In addition, even multiple dental cleaning devices can also be attached to a single food container without departing from the spirit and scope of the present invention.

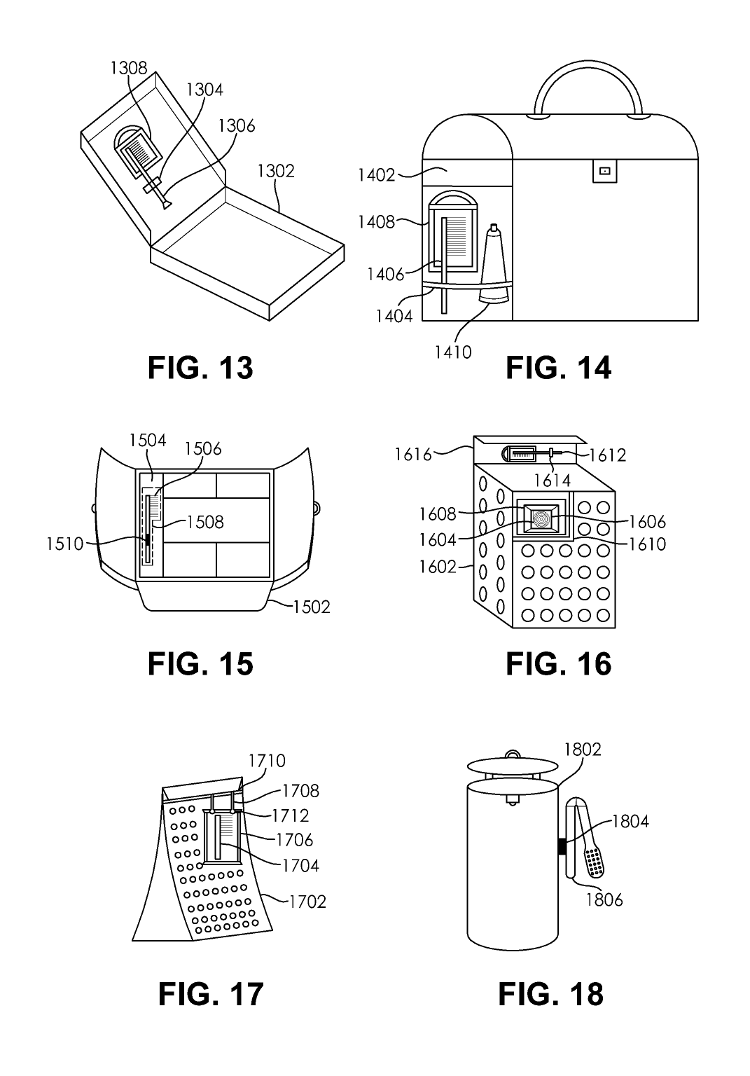

According to an embodiment of the present invention, as shown in FIG. 13, it illustrates an exemplary dental cleaning device, a conventional toothbrush 1306 with a cover 1308 for keeping bristles clean, attached to an exemplary food container, a carry out rectangular box 1302, using a tape 1304. Note: even a Velcro sticky back strip or a similar sticking or attaching material can be used instead of a tape to attach the dental cleaning device to the food container without departing from the spirit and scope of the present invention. In addition, multiple dental cleaning devices can also be attached to a single food container, and that too either within or outside the food container, without departing from the spirit and scope of the present invention.

According to an embodiment of the present invention, as shown in FIG. 14, it illustrates an exemplary food container, a lunch box 1402 with a special compartment 1404 to hold an exemplary dental cleaning device, a conventional toothbrush 1406 with a cover 1408 for keeping bristles clean, and an exemplary dental cleaning accessory, a toothpaste 1410. The special compartment on the lunch box can also include an exemplary placeholder indicator (for example: text referring to dental cleaning section), which would indicate and remind the users that the dental cleaning devices can be kept in that specially designated section of the food accessory. However, note that when the users directly insert the dental cleaning device anywhere on or right next to the food accessories without even the placeholder indicators being present, that would also be considered within the spirit and scope of the present invention.

According to an embodiment of the present invention, as shown in FIG. 15, it illustrates an exemplary food container, a box 1502, with a built-in special compartment 1504 to hold an exemplary dental cleaning device, a conventional toothbrush 1506, using magnet 1510 that's affixed to both the exemplary food container and the exemplary dental cleaning device. A person of ordinary skill in the art would recognize that when one of the exemplary food container or the exemplary dental cleaning device is completely or partially made of ferrous components like iron, cobalt, nickel, etc, then the magnet 1510 would just need to be affixed to the remaining food container or the dental cleaning device since the magnet would attract to the ferrous objects, and that would be within the spirit and scope of the present invention. In addition, such magnet 1510 can either be visibly located outside or embedded inside (invisible from outside) the exemplary dental cleaning device or the exemplary food container, and that would also be within the spirit and scope of the present invention. Note: whether the magnet 1510 is located outside or embedded inside, it would still be able to maintain its magnetic field. In addition, as shown in the figure, the special compartment 1504 on the box can also include an exemplary placeholder indicator (for example: an outline of toothbrush) 1508, which would indicate and remind the users that the dental cleaning devices can be kept in that specially designated section of the food accessory. The main intent of such special compartments or placeholder indicators is to remind users that dental cleaning devices are important to maintain good oral health, and therefore, they deserve a spot either within or right next to the food accessories. However, note that when the users directly insert the dental cleaning device anywhere on or right next to the food accessories without even the placeholder indicators being present, that would also be considered within the spirit and scope of the present invention.

According to an embodiment of the present invention, as shown in FIG. 16, it illustrates an exemplary dental cleaning device, a dental floss 1604 within its protective case 1606 and covered in a plastic wrap 1608, that's inserted in a pouch 1610 attached to an exemplary food container, a box of cookies 1602. Such pouch 1610 can be made of plastic, paper or any other material as long as it can be affixed (for example: glued) to the food container and can hold the dental cleaning device in it. For example: such pouch 1610 can be similar to a computer CD case that allows to insert items in it and can also be affixed to a food container. In addition to the inserting mechanism detailed above for inserting a dental cleaning device within a food container, the figure also illustrates an exemplary dental cleaning device, a conventional toothbrush 1612, attached to the lid 1616 of the food container 1602 using an attachment 1614 (for example: a tape). Note: Such attachment 1614 can also include other materials as long as they can help to attach the dental cleaning device to the food container, and that would also be within the spirit and scope of the present invention. Note: By attaching or inserting the dental cleaning devices at such prominent locations as shown in FIG. 16, it's clear that this invention would also help to provide a reminder to the users to frequently clean their teeth or gums whenever they open the food container.

Additionally, as illustrated in FIG. 16, a person of ordinary skill in the art would recognize that the intent of covering the dental cleaning device in plastic wrap 1608 or a similar wrap is not only to protect the dental cleaning device but also to clearly distinguish the dental cleaning device from the other contents of the food container. However, even if the dental cleaning device 1604 isn't covered in a wrap before inserting it in the pouch 1610 of the food container 1602, then that would still be within the spirit and scope of the present invention. Also, it is to be clearly understood that even a different food container like a cereal box, box of snacks, etc. would also be a valid example under this invention as long as a dental cleaning device can be held (for example: attached, affixed, inserted, placed, embedded, etc.) on the food accessory.

According to an embodiment of the present invention, as shown in FIG. 17, it illustrates an exemplary dental cleaning device, a conventional toothbrush 1704 covered in a plastic wrap 1706, and inserted in an exemplary food container, i.e. a big packet of chocolates 1702, using a suspender 1708 that's attached 1710 (for example: glued) to the food container on one of its sides and attached 1712 (for example: glued) to the dental cleaning device (or its cover) on the other side. Such suspender 1708 can be made of any material and can have any shape as long as it can be affixed (for example: glued) to the food container and can act as an inserting mechanism i.e. suspend the dental cleaning device within or outside the food container. A person of ordinary skill in the art would recognize that the intent of covering the dental cleaning device in plastic wrap 1706 or a similar wrap is to protect the dental cleaning device and also to clearly distinguish the dental cleaning device from the other contents of the food container. However, even if the dental cleaning device isn't covered in a wrap before inserting it in the food container, then that would still be within the spirit and scope of the present invention. A person of ordinary skill in the art would also recognize that multiple dental cleaning devices can also be suspended, inserted, placed, embedded or attached to a single food container, and that too either within or outside the food container, without departing from the spirit and scope of the present invention.

According to an embodiment of the present invention, as shown in FIG. 18, it illustrates an exemplary dental cleaning device, a foldable toothbrush 1806 with a magnet 1804 on its handle, which allows it to be attached to an exemplary metal food container, an iron box 1802. Such magnet 1804 on the toothbrush can either be visibly located outside on the toothbrush handle or it can also be embedded inside (invisible from outside) within the handle of the toothbrush, however, in either case the magnet 1804 would still be able to maintain its magnetic field. Since a magnet usually attracts to ferrous objects like iron, cobalt, nickel, etc. or it can attract to another magnet with unlike magnetic pole, A person of ordinary skill in the art would recognize that even those food accessories that don't attract magnets can also have a separate magnet affixed (for example: attached, glued, etc.) to them such that a dental cleaning device with magnet (of opposite magnetic pole) on its handle would get attracted and attached to the affixed (for example: attached, glued, etc.) magnet on the food accessory, and that would be within the spirit and scope of the present invention. In short, using a magnet as necessary on either both or individually on the dental cleaning device and the food container, a dental cleaning device can be attached to a food accessory. (Note: Like poles of a magnet repel, however, unlike poles of a magnet attract, so the magnets would need to be attached or embedded on either the food related accessory or the dental cleaning device such that they attract each other. Additionally, a magnet can be affixed at any place on the toothbrush handle, however, near the end of the handle would be better so the users don't put the magnet in mouth while cleaning their teeth or gums.)

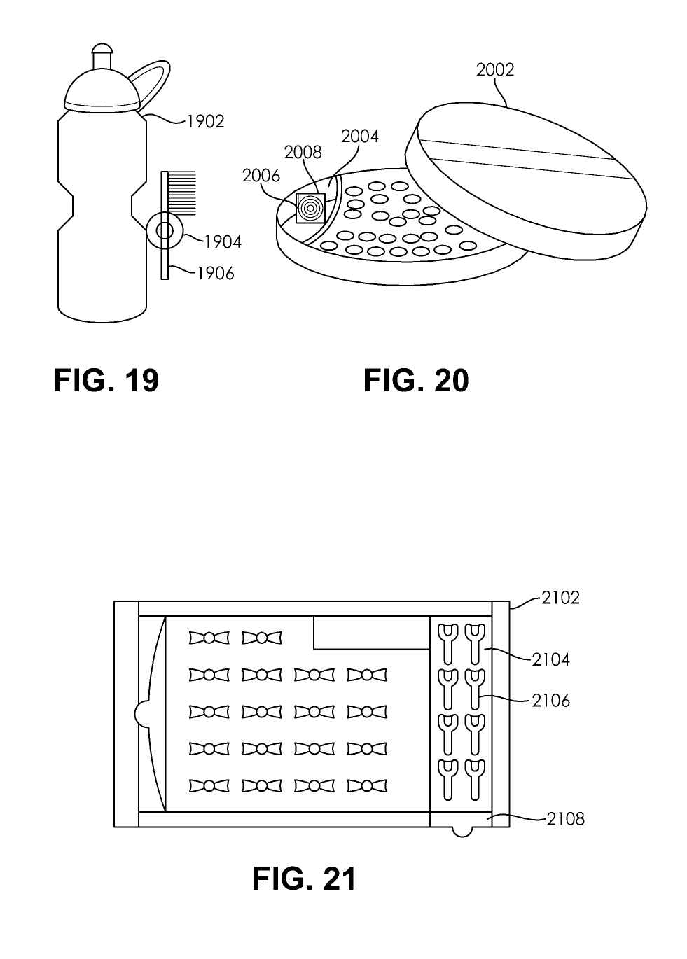

According to an embodiment of the present invention, as shown in FIG. 19, it illustrates an exemplary food container, a bottle 1902 with an attachment 1904, which can hold an exemplary dental cleaning device, a conventional toothbrush 1906. This figure demonstrates how a user can even attach a dental cleaning device to drink accessories. The attachment 1904 illustrated in the figure includes a round material with hole in the center, which can hold a dental cleaning device like a toothbrush, and that attachment is affixed (for example: glued) to the food container, i.e. a bottle, on one side. Such attachment 1904 can be made of any material and can have any shape as long as it can attach to or hold the dental cleaning device. A person of ordinary skill in the art would recognize that the dental cleaning device can even have a suction cup like attachment on it, which allows the dental cleaning device to be attached to an exemplary food container or utensil. Also, if the suction cup like attachment is affixed to the food container or utensil, then that would also allow the dental cleaning device to be attached to the suction cup attachment, and therefore to the food container or utensil.

According to an embodiment of the present invention, as shown in FIG. 20, it illustrates an exemplary food container, a box of chocolates 2002, with a special compartment 2004 to hold the exemplary dental cleaning device, i.e. a dental floss 2006, wherein the dental floss case is affixed to the said special compartment 2004 of the box using an adhesive 2008. This embodiment would allow the users, who consume the chocolates, to pull out the floss directly from the dental floss case that's affixed to the chocolate box. Note: The special compartment 2004 of the box can also include an exemplary placeholder indicator, which indicate and/or remind users that the special compartment is allocated for the dental cleaning devices. A person of ordinary skill in the art would also recognize that rather than inserting the dental cleaning devices on the special compartment of the box, the dental cleaning devices can also be attached to any other place on the box as long as the user can use them. For example: dental cleaning device can even be attached to exterior or interior rim of the box, cover of the box, etc.

According to an embodiment of the present invention, as shown in FIG. 21, it illustrates an exemplary food container, a big plastic packet of chocolates 2102, which has a separate section 2104 to hold exemplary dental cleaning devices, i.e. multiple Y shaped dental flosses 2106. In addition, the embodiment also includes a separate cover 2108 for opening the dental cleaning devices' section. In short, this arrangement allows the chocolates and the dental cleaning devices to be placed in completely separate sections with separate covers for opening those sections, however, everything still resides within one big packet. Note: Note: there can also be placeholder indicators on the dental cleaning devices' section of the box, which indicate and/or remind users that the separate section is allocated specially for the dental cleaning devices.

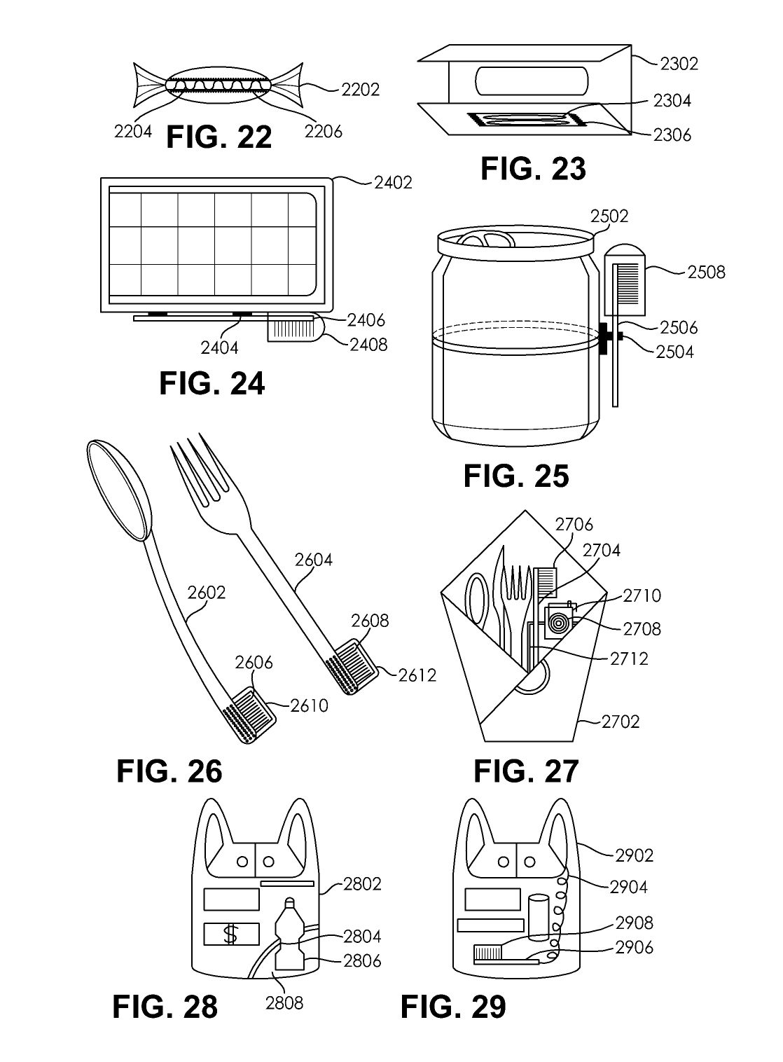

According to an embodiment of the present invention, as shown in FIG. 22, it illustrates an exemplary food container, a chocolate wrapper 2202, with an attached exemplary dental cleaning device, a dental floss 2204 within a cover 2206, surrounding the outer wall of the wrapper. As illustrated, the dental floss within its cover is attached using a glue (for example: temporary adhesive that produces a non-permanent joint) to the chocolate wrapper, however, even a tape, booger glue, gooey glue, Velcro sticky back strip or a similar sticking or holding material can be used to attach the dental cleaning device to the food container without departing from the spirit and scope of the present invention. Overall, this illustration shows how the individual food items or accessories like an individual chocolate wrapper 2202 can even have a dental cleaning device like a floss 2204 attached to them. This would not only provide users with easy access to dental cleaning devices but also remind users to clean their teeth or gums after they have consumed their foods.

A person of ordinary skill in the art would recognize that a dental cleaning device, for example: a floss, can be attached to food accessories, for example: a chocolate wrapper, at any place (internally or externally) and in any form or pattern. (For example, a floss can also be attached in a rounded pattern at the corner points where the chocolate wrapper is usually folded, etc.) A person of ordinary skill in the art would also recognize that a dental cleaning device, for example: a floss, can be attached to the food container, for example: a chocolate wrapper, either directly or within a protective cover, and either of those would still be within the spirit and scope of the present invention. Additionally, A person of ordinary skill in the art would also recognize that a dental cleaning device, for example: a floss, can also be embedded as part of the food container, for example: a wrapper, so once a user is done eating the food item, for example a chocolate, then the user can just snap out or pull out the floss from the wrapper and/or its covering, and use it for cleaning their teeth or gums.

According to an embodiment of the present invention, as shown in FIG. 23, it illustrates an exemplary food container, an open chocolate wrapper 2302, with an attached exemplary dental cleaning device, a dental floss 2304 within a cover 2306, located within multiple folds of the inner wall of the wrapper. In this example, a dental floss 2304 within its cover 2306 is first wrapped within couple of small folds of one end of the chocolate wrapper, and then the remaining wrapper is used to wrap the chocolate. Using this method, both the chocolate and the floss can simply co-exist in the same wrapper, however, there is a separation between both of them using the folds of the wrapper itself. In short, if the user unwraps that chocolate wrapper, then they would first see the chocolate, and then if they unfold the remaining folds that are present on one side of the chocolate wrapper, then they would also see the dental cleaning device i.e. a floss, either with or without its covering.

According to an embodiment of the present invention, as shown in FIG. 24, it illustrates an exemplary food container, a packet of chocolate bar 2402, with an attached exemplary dental cleaning device, a conventional toothbrush 2406 with a cover 2408 for keeping bristles clean. The attachment 2404 illustrated in the figure is that of a booger glue or E-Z-Release glue, which provides temporary adhesiveness and helps to attach the dental cleaning device to the food container i.e. a packet of chocolate bar. After eating some or all of the edible contents within the chocolate bar packet, a user can pull out the toothbrush from the packet to clean their teeth or gums. A person of ordinary skill in the art would recognize that instead of the above mentioned booger/E-Z-Release glue, even other products that help to create temporary adhesiveness (example: tape, etc.), which produce a removable, non-permanent joint, can also be used without departing from the spirit and scope of the present invention. A person of ordinary skill in the art would also recognize that even the entire dental cleaning device can be first placed within a cover (for example: plastic cover, etc.), and then that cover can also be attached to the food container without departing from the spirit and scope of the present invention.

According to an embodiment of the present invention, as shown in FIG. 25, it illustrates an exemplary food container, a cylindrical metal can 2502 with an attachment 2504 to hold an exemplary dental cleaning device, a conventional toothbrush 2506 along with a cover 2508 to keep bristles clean. The attachment 2504 illustrated in the figure includes a round band that tightly fits the cylindrical metal can and has a claw shaped rubber structure on one of its sides, which can hold the dental cleaning device on it. Note: the round band mentioned above can include any material as long as that material can be affixed to the food container and can hold the dental cleaning device on it. Note: other components can also be attached or embedded on the attachment 2504 to be able to hold the dental cleaning devices. A person of ordinary skill in the art would recognize that such attachment 2504 isn't limited to any of the exemplary details mentioned above and can also include other components, combinations and features that can hold the dental cleaning device on the food accessory without departing from the spirit and scope of the present invention.

According to an embodiment of the present invention, as shown in FIG. 26, it illustrates an exemplary food related accessory, a spoon 2602, which has an exemplary dental cleaning device, i.e. bristles 2606, embedded or attached at the back of the spoon's handle, and the bristles have cover 2610 in order to keep them clean. Similarly, FIG. 26 also illustrates another exemplary food related accessory, a fork 2604, which has an exemplary dental cleaning device, i.e. bristles 2608, embedded or attached at the back of the fork's handle, and the bristles have cover 2612 in order to keep them clean. Note: In the above examples shown in FIG. 26, the bristles can also be embedded or attached to the utensil handle similar to how the bristles are embedded or attached on a conventional toothbrush. For example: bristles can be positioned into the holes created at the base of the utensil handle and then fastened with tiny staples or similar attaching process. In fact, even any other embedded or attaching process would also be considered within the spirit and scope of the present invention as long as that process can embed/attach the bristles to the food accessories. Note: After eating food with the above mentioned utensil, a user can simply remove the cover from the bristles and clean their teeth or gums with the other end of the utensil that has the embedded or attached bristles. Note: A person of ordinary skill in the art would recognize that the covers 2610, 2612 illustrated in the figure are used to keep bristles clean, however, the cover is for good hygiene purposes and isn't always necessary. Hence, a simple utensil or even any other food related accessory with embedded or attached bristles, however without the cover, would also within the spirit and scope of the present invention.

According to an embodiment of the present invention, as shown in FIG. 27, it illustrates exemplary dental cleaning devices, a conventional toothbrush 2704 and a dental floss 2708 within their respective covers 2706, 2710, inserted within a separate section 2712 of an exemplary food related accessory, a folded table napkin 2702, which also holds the conventional fork, knife, spoon, etc. within that same table napkin. Note: Such folded table napkins 2702 are usually kept on the dining table along with other food accessories, but conventionally they only include those accessories that can help the users to consume the foods. However, based on this invention, the folded table napkin would also have a separate section 2712 affixed to it, which would also hold the dental cleaning devices 2704, 2708. A person of ordinary skill in the art would recognize that the separate section on the table napkin can be either made of the same material as the table napkin itself or can also be made of any other material as long as it can hold A person of more dental cleaning devices in it. A person of ordinary skill in the art would also recognize that instead of putting the dental cleaning devices in the separate section of the table napkin, they can also be kept directly or using any other medium within the table napkin itself along with the conventional food accessories like fork, knife, spoon, etc. and that would also be within the spirit and scope of the present invention. Additionally, A person of ordinary skill in the art would recognize that instead of a table napkin, sometimes the food accessories like a fork, spoon, paper napkin, straw, mouth freshener, etc. are even kept on side (for example, in restaurants), where the users can themselves pick them up and use them. Similarly, it is to be clearly understood that the dental cleaning devices can also be placed on side along with the other food accessories, and that would still be within the spirit and scope of the present invention.

According to an embodiment of the present invention, as shown in FIG. 28, it illustrates an exemplary bag i.e. a purse 2802 carrying either food, food container or food accessories, and includes a separate section 2804 that can hold the dental cleaning devices such as an antiseptic mouthwash 2806, etc. Additionally, as illustrated in the figure, there is also an exemplary placeholder indicator 2808 (for example: text referring to the dental cleaning device section) on the purse, indicating and/or reminding users that the special compartment 2804 has been allocated to hold the dental cleaning devices. Such placeholder indicators can also be in any other form (for example: image, bright light, embossed, debossed text, etc.) as long as they can convey the intent of placing a dental cleaning device on the particular section of food accessory.

According to an embodiment of the present invention, as shown in FIG. 29, it illustrates an exemplary bag i.e. a purse 2902 carrying either food, food container or food accessories, and also has a built-in wire 2904 connecting the bag and the exemplary dental cleaning device, a conventional toothbrush 2906 along with a cover 2908 to keep bristles clean. Such exemplary wire 2904 can be either affixed (for example: glued) to the bag as well as the dental cleaning device, or there can be an attachment on the bag as well as the dental cleaning device where the wire can be fastened on both sides. In addition, there can be also be a combination of wire being affixed, fastened to attachments, fastened to holes on both sides or other potential means can also be used to attach the wire to the food accessory as well as the dental cleaning device without restricting it to the examples mentioned above. In addition, A person of ordinary skill in the art would also recognize that there can also be a special section assigned in the purse where the dental cleaning devices can be held (for example: attached, affixed, inserted, placed, embedded, etc.) without departing from the spirit and scope of the present invention.

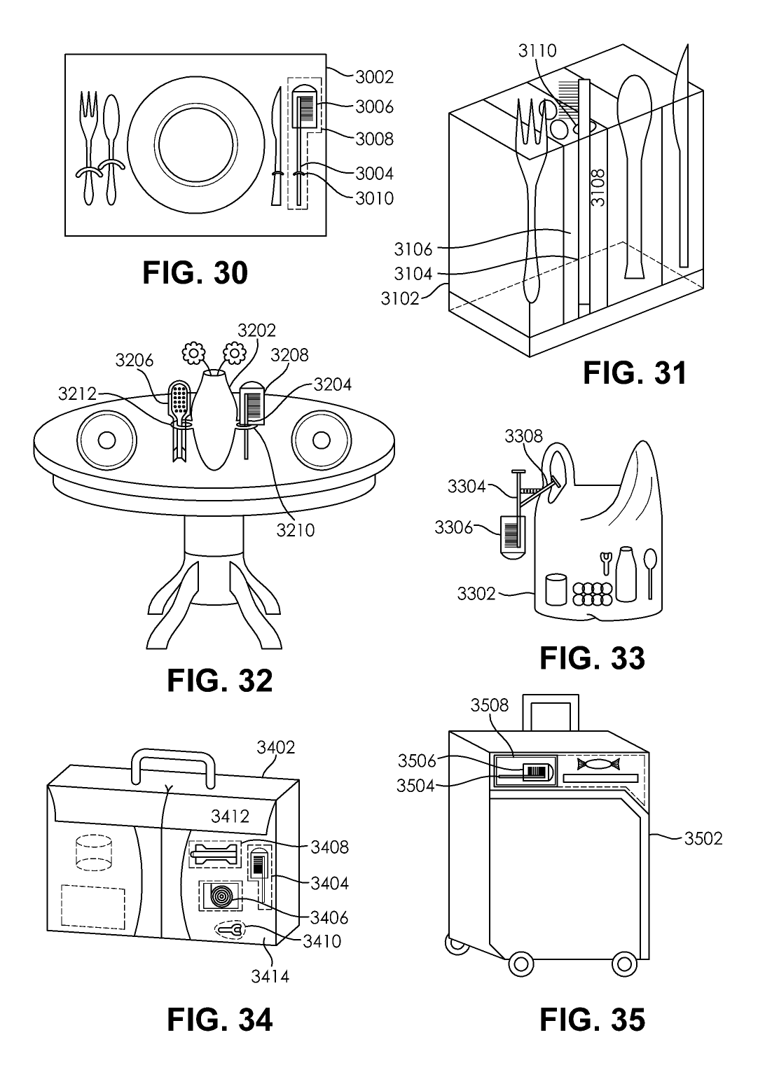

According to an embodiment of the present invention, as shown in FIG. 30, it illustrates an exemplary dental cleaning device, a conventional toothbrush 3004, attached to an exemplary food related accessory, a dining table mat 3002 using an attachment 3010. Note: Such attachment 3010 can be made of any material and can have any shape as long as it can hold the dental cleaning device. (For example: an attachment can be a small strip of plastic that's affixed (for example: glued) on its ends to the dining table mat such that a small semi-circle with a hole is created and can hold a dental cleaning device in it.) In addition, as illustrated in the figure, there is also an exemplary placeholder indicator 3008 on the dining table mat 3002, indicating that the dental cleaning device 3004 can be kept on that special section of the dining table mat. In addition, as illustrated in the figure, toothbrush 3004 also has a cover 3006 to keep the bristles clean, however, note that such cover isn't always necessary. Additionally, as illustrated in this figure, the exemplary placeholder indicator 3008 includes an embossed outline of toothbrush. However, such exemplary placeholder indicators can either be an embossed, debossed or even regular placeholder image or text referring to a dental cleaning device, or it can also be another form of representation as long as they can convey the intent of placing a dental cleaning device on the particular section of food accessory. Such placeholder indicators 3008 also serve as a visual reminder for the users that a dental cleaning device can be placed in the allocated section of the food accessory. A person of ordinary skill in the art would recognize that this invention would also include where users directly insert the dental cleaning device anywhere on or right next to the food accessories (for example: dining table mat) without even the placeholder indicators being present.

Note: Conventionally, only those accessories are placed on a dining table mat that can help the users to consume the foods. However, as illustrated in FIG. 30, it is to be clearly understood that even a dental cleaning device 3004 is equally as important as the other food accessories, and therefore, they can also be attached to a food related accessory (for example: a dining table mat) along with the other conventional food accessories like fork, spoon, knife, etc. In addition, rather than attaching the conventional toothbrush on the dining table mat, A person of ordinary skill in the art would recognize that the toothbrush can also be placed on the dining table mat with the help of the placeholder indicators, and that would be considered within the spirit and scope of the present invention.

According to an embodiment of the present invention, as shown in FIG. 31, it illustrates an exemplary food related accessory, a cutlery holder 3102, with a built-in special compartment 3106 to be able to hold an exemplary dental cleaning device, a regular toothbrush 3104, along with the conventional fork, knife, spoon, etc. Additionally, as illustrated in the figure, the special compartment 3106 i.e. the dental cleaning device section of the cutlery holder 3102 can also include partition holes 3110 at the top, which would allow to keep the dental cleaning devices 3104 separate from each other and protect their bristles. In addition, as illustrated in the figure, there is also an exemplary placeholder indicator 3108 (for example: text referring to the dental cleaning device) on the food related accessory, i.e. a cutlery holder, which indicates and/or remind users that the special compartment has been allocated to hold the dental cleaning devices. Note: although placeholder indicators are good, however, A person of ordinary skill in the art would recognize that this invention would also include where the users directly insert the dental cleaning device on the food accessory, i.e. a cutlery holder, without the placeholder indicators being present. A person of ordinary skill in the art would also recognize that instead of the regular toothbrush, any other dental cleaning device (for example: an automated toothbrush, finger toothbrush, foldable toothbrush, one-time use toothbrush, dental floss, antiseptic/antibacterial mouthwash, cleaning bristles, dental cleaning twig, chewing stick, dental probiotic capsules, etc.) can also be placed in the exemplary food related accessory, i.e. a cutlery holder, without departing from the spirit and scope of the present invention.

According to an embodiment of the present invention, as shown in FIG. 32, it illustrates exemplary multiple dental cleaning devices, a conventional toothbrush 3204 and a foldable toothbrush 3206, hanging on an exemplary food related accessory, a dining table centerpiece 3202, using the attachments 3210, 3212. Note: Such attachments 3210, 3212 illustrated in the figure include a round material with hole in the center, which can hold a dental cleaning device like a toothbrush, etc. and the attachments are affixed (for example: glued) to the food related accessory, i.e. a dining table centerpiece, on one side. Such attachments can be made of any material and can have any shape as long as it can attach to or hold the dental cleaning device. Note: the conventional toothbrush 3204 illustrated in the figure also has a cover 3308 for keeping bristles clean, however, the cover isn't necessary in all situations. Overall, this figure demonstrates how a user can even attach a dental cleaning device to a food related accessory like a dining table centerpiece as long as that food related accessory is directly or indirectly involved with the food activities.

According to an embodiment of the present invention, as shown in FIG. 33, it illustrates an exemplary dental cleaning device, a conventional toothbrush 3304 with a cover 3306 for keeping bristles clean and a clip mechanism 3308 embedded at the bottom of the toothbrush handle that allows the toothbrush to be clipped to an exemplary bag i.e. a plastic bag 3302 carrying either food, food container or food accessories. The clip mechanism 3308 illustrated in the figure includes one of its arms as the base of the toothbrush itself, and the other arm of the clip is placed at an angle along with the spring in between the two arms, which allows the toothbrush to be clipped to any food accessory. Note: Such toothbrush with an embedded or attached clip can be clipped either outside or inside the food accessory, for example a bag. A person of ordinary skill in the art would recognize that rather than one arm of the clip being part of the toothbrush base itself, there can also be a stand-alone clip or another type of clip that can be affixed (for example: glued, attached, etc) to the toothbrush wherein as long as it can maintain the clipping effect, that would still be within the spirit and scope of the present invention. Note: When the dental cleaning device with the embedded or attached clip is unclipped from the bag, it would also be possible to make the dental cleaning device stand straight using the clip as its base support. Note such mechanism of clipping the dental cleaning device to the food accessories would make it easy for the users to access, distinguish and/or conveniently locate the dental cleaning device from the rest of the items. A person of ordinary skill in the art would recognize that other than a conventional toothbrush even any other dental cleaning devices can have an embedded or attached clip (similar to the details mentioned above) and that would be within the spirit and scope of the present invention. A person of ordinary skill in the art would also recognize that a user would also be able to detach the clip attachment at any time from the dental cleaning device, and use the dental cleaning device on its own, without departing from the spirit and scope of the present invention.

According to an embodiment of the present invention, as shown in FIG. 34, it illustrates exemplary dental cleaning devices, a conventional toothbrush 3404 with a cover for keeping bristles clean, a dental floss 3406 with a cover for keeping it clean, an antiseptic mouthwash 3408 and a Y shaped dental floss 3410 covered in plastic, inserted in the specially allocated dental cleaning device section 3414 in the front pouch of an exemplary bag carrying either food, food container or food accessories i.e. a laptop bag 3402 with food in its front pouch. Such non-obvious dental cleaning device section 3414 allocated on the laptop bag can also include an exemplary placeholder indicator 3412 (for example: text referring to the dental cleaning device) on the laptop bag, indicating and/or reminding users that the special section has been allocated to hold the dental cleaning devices. Such exemplary placeholder indicators can also be in any other form of representation as long as they can convey the intent of placing a dental cleaning device on the particular section of food accessory. Note: although placeholder indicators are good, however, A person of ordinary skill in the art would recognize that this invention would also include where the users directly insert the dental cleaning device on the specially allocated dental cleaning device section of the laptop bag, without the placeholder indicators even being present. Overall, this figure demonstrates how a user can even insert dental cleaning devices in a bag carrying either food, food container or food accessories as long as that bag is directly or indirectly involved with the food accessories, and that would be within the spirit and scope of the present invention.

According to an embodiment of the present invention, as shown in FIG. 35, it illustrates an exemplary dental cleaning device, a conventional toothbrush 3504 with a cover 3506 for keeping bristles clean, inserted in a specially allocated dental cleaning device section 3508 of an exemplary bag carrying either food, food container or food accessories i.e. a hand luggage bag 3502. Such non-obvious dental cleaning device section 3508 allocated on the hand luggage bag can also include an exemplary placeholder indicator (for example: an image of toothbrush, etc.), which would indicate and/or remind users that the dental cleaning devices can be kept in that section of the food accessory, and that would be within the spirit and scope of the present invention. The main intent of such specially allocated sections or placeholder indicators is to remind users that dental cleaning devices are important to maintain good oral health, and therefore, they deserve a spot either within or right next to the food accessories. Overall, this figure demonstrates how a user can even insert dental cleaning devices in a bag carrying either food, food container or food accessories as long as that bag is directly or indirectly involved with the food accessories, and that would be within the spirit and scope of the present invention.

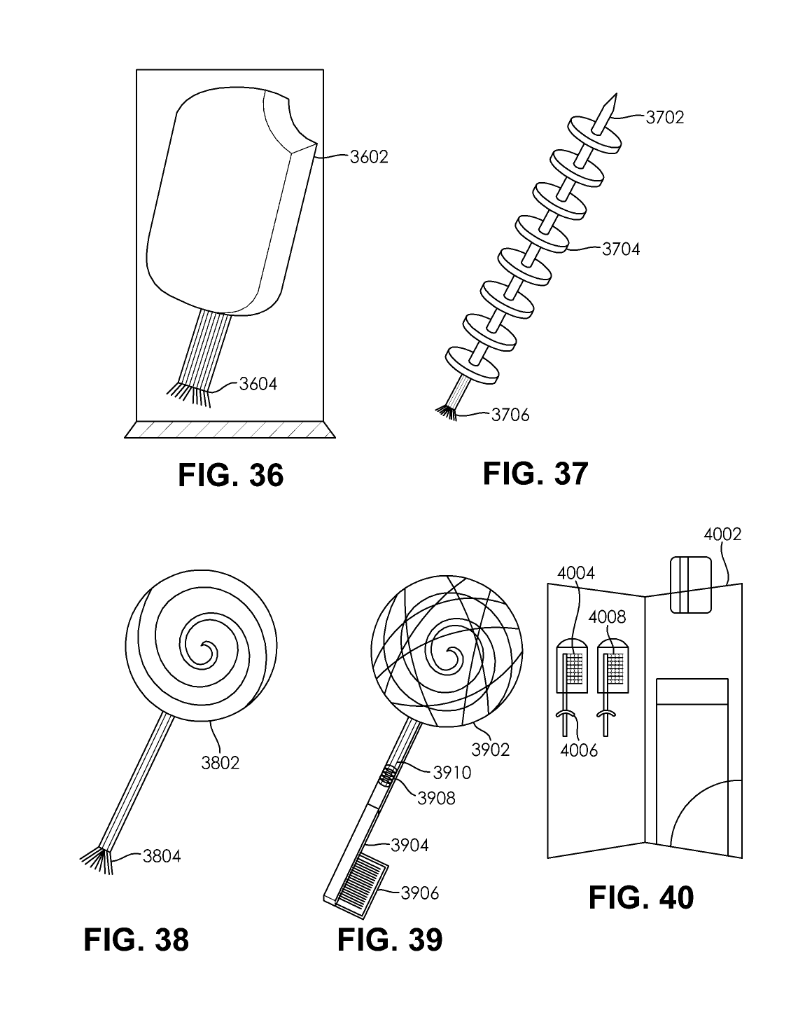

According to an embodiment of the present invention, as shown in FIG. 36, it illustrates an exemplary dental cleaning device, a cleaning stick 3604, which is embedded in the center of an exemplary food product, an ice cream 3602, instead of a regular wooden stick in the center. Note: once a user is done eating an ice cream, they can thereafter use the cleaning stick 3604 to clean their teeth or gums. A person of ordinary skill in the art would recognize that the cleaning stick 3604 shown in this FIG. 36 can also be replaced with a toothbrush or another type of dental cleaning device without departing from the spirit and scope of the present invention. In such case, the bristles or the dental cleaning component of the dental cleaning device can also be completely embedded within the ice cream itself where the handle of the toothbrush also acts as the handle of the ice cream. Additionally, there can also be a cover/case on top of the toothbrush bristles in order to protect them, and then a user can take that cover/case off when they are done eating the ice cream and are ready to clean their teeth or gums. Note: A person of ordinary skill in the art would recognize that the entire cleaning stick or toothbrush can also be within a cover, and that cover can be embedded partially within an ice cream, and the rest of the cover can act as the handle for holding the ice cream, and that would also be within the spirit and scope of the present invention. In this case, once the user is done eating the ice cream, they can take the dental cleaning device out of the cover and use it to clean their teeth or gums.

According to an embodiment of the present invention, as shown in FIG. 37, it illustrates an exemplary dental cleaning device, a cleaning stick 3706, that's affixed (for example: glued) to the back of a kabab stick (skewers) 3702, which is further inserted in an exemplary food product, a kabab 3704. In this case, once a user is done eating the kabab 3704, then they can use the cleaning stick 3706 to clean their teeth or gums. A person of ordinary skill in the art would recognize that instead of using the cleaning stick, even other dental cleaning devices that can sustain the grill fire can also be used in this example without departing from the spirit and scope of the present invention.

According to an embodiment of the present invention, as shown in FIG. 38, it illustrates an exemplary dental cleaning device, a cleaning stick 3804, where a part of the cleaning stick is embedded on an exemplary food product, a lollipop chocolate 3802, and the remaining part of the cleaning stick acts as an handle to hold the food product. In this case, once a user is done eating the lollipop chocolate 3802, then they can use the cleaning stick 3804 to clean their teeth or gums. A person of ordinary skill in the art would recognize that instead of using the cleaning stick, even other dental cleaning devices that are suitable for embedding on a food product can also be used without departing from the spirit and scope of the present invention.

According to an embodiment of the present invention, as shown in FIG. 39, it illustrates an exemplary dental cleaning device, an upside down conventional toothbrush 3904 with a bristle cover 3906, where the handle of that toothbrush is embedded in the center of an exemplary food product, a lollipop chocolate 3902, rather than a traditionally used plastic stick in the center. In this case, once a user is done eating the lollipop chocolate 3902, then they can use the embedded toothbrush 3904 to clean their teeth or gums. Note: the conventional toothbrush 3904 illustrated in the figure has a cover 3906 for keeping bristles clean, however, the cover isn't always necessary. The details mentioned above are sufficient to embed the dental cleaning device to the food product, however, A person of ordinary skill in the art would recognize that the toothbrush 3904 demonstrated in the figure can also have multiple layers 3910 of its handle, such that the sticky top layer (for example: because of the stickiness of the lollipop chocolate) can be removed from the toothbrush by twisting that layer counter-clockwise and unscrewing the layer from the swirly threads 3908 of the handle, and that would also be within the spirit and scope of the present invention. This additional feature would allow the sticky top layer of the toothbrush handle to be easily removed once the user has consumed the lollipop chocolate, however the interior layer within the handle would still remain and allow the user to hold the toothbrush using those interior layer. A person of ordinary skill in the art would recognize that such toothbrush with multiple layers of the handle can also exist separately on its own such that they can also be inserted, embedded, placed or attached to a food accessory without departing from the spirit and scope of the present invention. Additionally, A person of ordinary skill in the art would recognize that such toothbrush with multiple layers of the handle can have different graphic images (for example: cartoon characters) on each handle layer, and that would be within the spirit and scope of the present invention. Alternatively, A person of ordinary skill in the art would recognize that a user would also have the ability to completely detach the partial base portion (sticky bottom) of the toothbrush handle (for example: because of the stickiness of the lollipop chocolate), and that would also be within the spirit and scope of the present invention.

According to an embodiment of the present invention, as shown in FIG. 40, it illustrates exemplary dental cleaning devices, i.e. multiple toothbrushes 4004 along with bristle covers, where each toothbrush is inserted using individual attachments 4006 on an exemplary food related accessory, a restaurant bill/check holder 4002. Such exemplary food related accessory, i.e. a restaurant bill/check holder, is usually presented to the patrons after the food is consumed, and can have several small attachments 4006 affixed (for example: glued, attached, etc.) to it such that they can hold A person of multiple dental cleaning devices 4004. Note: Such attachments 4006 can be made of any material and can have any shape as long as they can attach to or hold the dental cleaning devices. (For example: an attachment can be a small strip of leather that's affixed (for example: glued) on its ends to the bill/check holder such that a small semi-circle with a hole is created and can hold a dental cleaning device in it.) Note: the patrons would be able to take the dental cleaning devices out of the bill/check holder attachments and use them to clean their teeth or gums. Note: A person of ordinary skill in the art would recognize that the attachments 4006 that are illustrated inside the bill/check holder can also be outside on such bill/check holders without departing from the spirit and scope of the present invention.

Additionally, as shown in FIG. 40, A person of ordinary skill in the art would recognize that the toothbrush/toothbrushes 4004 can also include bristles that are covered with dry mouth freshener 4008 (for example: menthol, powdered fennel seeds, etc.), and that would be within the spirit and scope of the present invention. For example: to cover the bristles with dry mouth freshener, the mouth freshener would be first crushed to create a powder form and then it would be mixed with water to create a liquid form, and thereafter, the liquid mouth freshener would be poured on the toothbrush bristles and allowed to dry, which would result in the mouth freshener to temporarily stick to the toothbrush bristles. In this case, when the users use such toothbrush to clean their teeth or gums, they don't really need the toothpaste along with it because brushing the teeth with a plain toothbrush can also help to reduce plaque build-up and gum bleeding to a good extent, and in addition, users can also get rid of the bad breath in their mouth because of the edible dry mouth freshener present on the toothbrush bristles. Note: other than water, even other products can also be used along with the powdered mouth freshener as long as they can help the mouth freshener to temporarily stick to the toothbrush bristles. In addition, A person of ordinary skill in the art would recognize that a toothbrush comprising of bristles covered with dry mouth freshener can also exist separately on its own where such toothbrush can also be embedded, inserted, placed or attached to a food accessory without departing from the spirit and scope of the present invention.

Overall, note that any of these embodiments shown in this invention are just exemplary of the broader invention, however, they do illustrate that any dental cleaning device can be easily held (for example: attached, affixed, inserted, placed, embedded, etc.) on the food accessories, providing a visual reminder to the users to frequently clean their teeth or gums and also making the dental cleaning devices within easy access of the users. This easy access of dental cleaning devices can indirectly enable the users to frequently clean their teeth or gums, and therefore, avoid a lot of dental problems and their associated expenses.

Additionally, A person of ordinary skill in the art would recognize that there are many different types of dental cleaning devices, food utensils, food containers, food accessories, bags used for carrying foods or food containers or food accessories, and the food products themselves, etc. Therefore, rather than limiting the invention to just the embodiments shown in this document, it is to be clearly understood that all other dental cleaning devices, food utensils, food containers, food accessories, bags used for carrying foods or food containers or food accessories, food products themselves, etc. would also be within the spirit and scope of the present invention.

In addition, A person of ordinary skill in the art would recognize that any of the illustrated figures of this invention can also have substitute components, combinations and/or features as long as the intent of holding (for example: attaching, affixing, inserting, placing, embedding, etc.) a dental cleaning device on the food accessory is maintained.

Many alterations and modifications may be made by those having ordinary skill in the art without departing from the spirit and scope of the embodiments. Therefore, it must be understood that the illustrated embodiments have been set forth only for the purposes of example and that it should not be taken as limiting the embodiments as defined by the following embodiments and its various embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

Insubstantial changes from the claimed subject matter as viewed by a person with ordinary skill in the art, now known or later devised, are expressly contemplated as being equivalently within the scope. Therefore, obvious substitutions now or later known to one with ordinary skill in the art are defined to be within the scope and spirit of the invention.

1-30. (canceled)

31. A holding mechanism for coupling a dental cleaning device to a plate, said holding mechanism comprising:
a plate;
a dental cleaning device; and
a clip, wherein a first end of said clip is configured to grasp a rim of said plate and a second opposite end of said clip comprises a gripper configured to hold said dental cleaning device,
wherein said gripper is configured to receive a handle portion of said dental cleaning device, such that when said handle portion is inserted in the gripper said dental cleaning device is held perpendicular to said clip and is suspended in a plane parallel to a surface upon which said plate rests.

32. The holding mechanism of claim 31, wherein said first end is a jaw for grasping said rim.

33. The holding mechanism of claim 32, wherein said jaw comprises grooves on a grasping surface of said jaw.

34. The holding mechanism of claim 31, wherein said dental cleaning device is a toothbrush.

35. The holding mechanism of claim 34, wherein said toothbrush includes a cover enclosing the bristles of said toothbrush.

36. A holding mechanism for coupling a dental cleaning device to a plate, said holding mechanism comprising:
a plate;
a dental cleaning device; and
a retaining structure extending from said plate, wherein said retaining structure is configured to grip a handle of a dental cleaning device and suspend said dental cleaning device in a plane parallel to the surface upon which the plate rests.

37. The holding mechanism of claim 36, wherein said dental cleaning device is a toothbrush.

38. The holding mechanism of claim 37, wherein said retention structure includes a first set of aligned retention slots in which different segments of a handle of said toothbrush can be securely inserted.

39. The holding mechanism of claim 37, wherein said retention structure includes a second set of aligned retention slots, adjacent to said first set of aligned slots, which is configured to receive a tube of toothpaste and securely retain said tube of toothpaste in a plane parallel to the surface upon which said plate rests.

40. The holding mechanism of claim 37, wherein said toothbrush has a removable bristle head.

41. The holding mechanism of claim 36, wherein said retaining structure extends from a rim of said plate.

42. The holding mechanism of claim 37, wherein the retaining structure comprises:
a first clip at one end thereof; and
a second clip at an opposite end thereof, wherein said first clip is configured to grip the rim of said plate and said second clip is configured to grasp a handle of said toothbrush,
wherein said second clip securely retains said toothbrush in a plane parallel to a surface upon which said plate rests.

43. The holding mechanism of 37, wherein said toothbrush includes a cover enclosing the bristle head of said toothbrush.

44. The holding mechanism of claim 37, wherein said toothbrush is a foldable toothbrush.

45. The holding mechanism of claim 42, wherein said first clip is an alligator clip.

46. The holding mechanism of claim 42, wherein said second clip is a snap-in clip.

47. A holding mechanism for coupling a dental cleaning device to a plate, said holding mechanism comprising a plurality of clips configured to attach a spine of a toothbrush to an edge of a plate.

48. The holding mechanism of claim 47, wherein said toothbrush spine is attached to said edge so that the entire spine is flush with said edge.

49. The holding mechanism of claim 47, wherein said toothbrush includes a cover enclosing the bristle head of said toothbrush.

50. The holding mechanism of claim 47, wherein said clips are embedded in the dental cleaning device.

51. A holding mechanism for coupling a dental cleaning device to a food utensil, said holding mechanism comprising:
a food utensil;
a dental cleaning device; and
a clip, wherein one end of said clip is configured to grip an edge of said food utensil and an opposite end of said clip comprises a gripper configured to hold said dental cleaning device.

52. The holding mechanism of claim 51, wherein said food utensil is selected from the group consisting of a: plate, bowl, cup, mug, and pan.

53. The holding mechanism of claim 51, wherein said dental cleaning device is a toothbrush.

54. The holding mechanism of claim 53, wherein said toothbrush has a removable bristle head.

55. The holding mechanism of claim 53, wherein said toothbrush includes a cover enclosing the bristles of said toothbrush.
